(19) United States
(12) Patent Application Publication
(10) Pub. No.: US 2007/0179636 A1
(43) Pub. Date: Aug. 2, 2007

(54) Drive system and control method of the same

(76) Inventor: Masahiro Shige, Osaka-fu (JP)

Correspondence Address: KENYON & KENYON LLP, 1500 K STREET N.W., SUITE 700, WASHINGTON, DC, 20005, US

(21) Appl. No.: 10/592,574

(22) PCT Filed: Apr. 11, 2005
(86) PCT No.: PCT/JP05/07353

§ 371 Date: Sep. 12, 2006

(30) Foreign Application Priority Data
Apr. 12, 2004 (JP) 2004-116630

(51) Int. Cl. G05B 11/01

(52) U.S. Cl. 700/22

(57) ABSTRACT

When the current state of fuel cells 30 suggests a potential for an impending output restriction, the control procedure of the invention raises a target SOC level of a secondary battery 60 (step S170), and sets a charge level restriction Wch (step S180) to make the fuel cells 30 keep its current state having the potential for the impending output restriction. The control procedure charges the secondary battery 60 in the range of the set charge level restriction Wch (step S210) and causes a motor 36 to output a torque at a level of a preset torque demand Td* (step S230). The secondary battery 60 is thus chargeable without making the state of the fuel cells 30 approach to conditions for imposing an output restriction and is prepared for possible output restriction of the fuel cells 30.

### TECHNICAL FIELD

The present invention relates to a drive system, a control method of the drive system, and a moving object with the drive system mounted thereon.

### BACKGROUND ART

One proposed drive system has two power supply circuits, each including fuel cells and a secondary battery, mounted on a motor vehicle. In the event of any abnormality arising in the fuel cells of one power supply circuit, the state of charge (SOC) of the secondary battery in the abnormal power supply circuit is heightened with the electric power generated by the fuel cells in the other normal power supply circuit (see, for example, Japanese Patent Laid-Open Gazette No. 2003-333707). In this prior art drive system, the state of charge (SOC) of the secondary battery is heightened in the abnormal power supply circuit to ensure a sufficient level of power output corresponding to a demand.

### DISCLOSURE OF THE INVENTION

In a general fuel cell system, the output level of fuel cells is restricted for protection of the fuel cells, in response to detection of any abnormality of the fuel cells, for example, an excessive temperature rise of the fuel cells or a poor current-voltage characteristic of the fuel cells. In the prior art drive system having the two power supply circuits of the fuel cells and the secondary batteries, the state of charge (SOC) of the secondary battery in the abnormal power supply circuit is heightened with the electric power generated by the fuel cells in the normal power supply circuit to ensure the sufficient level of power output corresponding to a demand. In a drive system having only one power supply circuit, however, there is a difficulty in heightening the state of charge (SOC) of the secondary battery under output restriction of the fuel cells.

The drive system of the invention and the moving object with the drive system mounted thereon thus aim to ensure an adequate drive in response to a demand even under output restriction of electric power generated by a power generation device, such as fuel cells. The drive system of the invention and the moving object with the drive system mounted thereon also aim to adequately regulate a power storage level of an accumulator battery, such as a secondary battery.

In order to attain at least part of the above and the other related objects, the present invention is directed to a drive system, a control method of the drive system, and a moving object with the drive system mounted thereon, which have the configurations discussed below.

A first drive system of the invention includes: a power generation module that receives a supply of a fuel and generates electric power; an accumulator module that is chargeable with the electric power generated by the power generation module; a drive module that is actuated with a supply of the electric power generated by the power generation module and with a supply of electric power discharged from the accumulator module; a state detection module that detects a current state of the power generation module; and a control module that controls the power generation module to adjust a power storage level of the accumulator module to a first target storage level when the current state of the power generation module detected by the state detection module is within a preset state area included in an adequate state range where adequate operation of the power generation module is assured, while controlling the power generation module to adjust the power storage level of the accumulator module to a second target storage level when the current state of the power generation module detected by the state detection module is within the adequate state range but is out of the preset state area, and controlling the power generation module to adjust the power storage level of the accumulator module to either of the first target storage level and the second target storage level under restricted operation of the power generation module when the current state of the power generation module detected by the state detection module is out of the adequate state range.

The first drive system of the invention controls the power generation module to adjust the power storage level of the accumulator module to the first target storage level, when the detected current state of the power generation module is within the preset state area included in the adequate state range where adequate operation of the power generation module is assured. The first drive system controls the power generation module to adjust the power storage level of the accumulator module to the second target storage level, when the detected current state of the power generation module is within the adequate state range but is out of the preset state area. Namely the power storage level of the accumulator module is adjusted to the second target storage level when there is a possibility that the state of the power generation module currently within the adequate state range will soon depart from the adequate state range. This arrangement ensures adequate regulation of the power storage level of the accumulator module according to the detected state of the power generation module. The first drive system controls the power generation module to adjust the power storage level of the accumulator module to either the first target storage level or the second target storage level under restricted operation of the power generation module, when the detected current state of the power generation module is out of the adequate state range. This arrangement effectively prevents the excessive operation of the power generation module. Here the terminology ‘power storage level’ represents the electric capacity stored in the accumulator module or the state of charge of the accumulator module.

In the first drive system of the invention, the control module may set a drive state demand required for the drive module and control the drive module to be actuated in a specific drive state to fulfill the set drive state demand. This arrangement enables the drive module to be actuated in the specific drive state corresponding to the drive state demand. In this case, the control module may control the power generation module to generate a higher level of electric power with an increase in loading of the set drive state demand. This arrangement enables the power generation module to generate the electric power in response to the drive state demand. Most of the electric power required for the drive module is thus suppliable from the power generation module.

Further, in the first drive system of the invention, the second target storage level may be higher than the first target storage level. This arrangement enables the drive module to be actuated for a longer time period even under the restricted operation of the power generation module.

Moreover, in the first drive system of the invention, the second target storage level may be set corresponding to the detected state of the power generation module. This arrangement sets the power storage level of the accumulator module corresponding to the state of the power generation module. In this case, the second target storage level may be set to increase with an approach of the detected state of the power generation module to a boundary of the adequate state range.

In one preferable embodiment of the first drive system of the invention, the power generation module includes a fuel cell stack and auxiliary machinery required for operation of the fuel cell stack, and the state detection module detects current states of both the fuel cell stack and the auxiliary machinery. In this embodiment, the state detection module may detect at least one of a temperature of the fuel cell stack, a voltage level of the fuel cell stack, a voltage level of a unit fuel cell included in the fuel cell stack, a current-voltage characteristic of the fuel cell stack, and a temperature of the auxiliary machinery, as the current state of the power generation module.

In another preferable embodiment of the first drive system of the invention, the control module controls the power generation module to keep the current state with an increase in power storage level of the accumulator module, when the current state of the power generation module detected by the state detection module is within the adequate state range but is out of the preset state area. This arrangement effectively prevents the state of the power generation module from departing from the adequate state range.

A second drive system of the invention includes an accumulator module that accumulates electric power therein; a power generation module that generates electric power in an allowable range to a preset output upper limit; a drive module that is actuated with a supply of the electric power generated by the power generation module and with a supply of electric power discharged from the accumulator module; a storage level regulation module that accumulates the electric power generated by the power generation module in the accumulator module to a preset target storage level; an output upper limit change module that changes the output upper limit of the power generation module according to a current state of the power generation module; a decrease potential detection module that detects a potential for an impending decrease in output upper limit by the output upper limit change module; and a target storage level rise module that raises the target storage level set by the storage level regulation module, in response to detection of the potential for the impending decrease in output upper limit by the decrease potential detection module.

The second drive system of the invention raises the target storage level of the accumulator module, which stores the electric power generated by the power generation module, in response to detection of the potential for the impending decrease in output upper limit of the power generation module according to the current state of the power generation module. This arrangement heightens the power storage level of the accumulator module to be prepared for a possible decrease in output upper limit of the power generation module, and increases the amount of electric power used in the drive system.

A moving object of the invention has either the first drive system or the second drive system of the invention mounted thereon and moves by actuation of the drive module. Here, the first drive system of the invention includes: a power generation module that receives a supply of a fuel and generates electric power; an accumulator module that is chargeable with the electric power generated by the power generation module; a drive module that is actuated with a supply of the electric power generated by the power generation module and with a supply of electric power discharged from the accumulator module; a state detection module that detects a current state of the power generation module; and a control module that controls the power generation module to adjust a power storage level of the accumulator module to a first target storage level when the current state of the power generation module detected by the state detection module is within a preset state area included in an adequate state range where adequate operation of the power generation module is assured, while controlling the power generation module to adjust the power storage level of the accumulator module to a second target storage level when the current state of the power generation module detected by the state detection module is within the adequate state range but is out of the preset state area, and controlling the power generation module to adjust the power storage level of the accumulator module to either of the first target storage level and the second target storage level under restricted operation of the power generation module when the current state of the power generation module detected by the state detection module is out of the adequate state range. The second drive system of the invention includes: an accumulator module that accumulates electric power therein; a power generation module that generates electric power in an allowable range to a preset output upper limit; a drive module that is actuated with a supply of the electric power generated by the power generation module and with a supply of electric power discharged from the accumulator module; a storage level regulation module that accumulates the electric power generated by the power generation module in the accumulator module to a preset target storage level; an output upper limit change module that changes the output upper limit of the power generation module according to a current state of the power generation module; a decrease potential detection module that detects a potential for an impending decrease in output upper limit by the output upper limit change module; and a target storage level rise module that raises the target storage level set by the storage level regulation module, in response to detection of the potential for the impending decrease in output upper limit by the decrease potential detection module.

The moving object of the invention has either the first drive system or the second drive system of the invention mounted thereon. The moving object of the invention may thus exert the similar effects to those of the first drive system. Namely the moving object of the invention ensures adequate regulation of the power storage level of the accumulator module according to the detected state of the power generation module, while effectively preventing the excessive operation of the power generation module. The moving object of the invention may also exert the similar effects to those of the second drive system. Namely the moving object of the invention heightens the power storage level of the accumulator module to be prepared for a possible decrease in output upper limit of the power generation module, and increases the amount of electric power used in the drive system.

A control method of the invention is a control method of a drive system, which includes: a power generation module that receives a supply of a fuel and generates electric power; an accumulator module that is chargeable with the electric power generated by the power generation module; and a drive module that is actuated with a supply of the electric power generated by the power generation module and with a supply of electric power discharged from the accumulator module, and the method includes the steps of: (a) detecting a current state of the power generation module; and (b) controlling the power generation module to adjust a power storage level of the accumulator module to a first target storage level when the detected current state of the power generation module is within a preset state area included in an adequate state range where adequate operation of the power generation module is assured, while controlling the power generation module to adjust the power storage level of the accumulator module to a second target storage level when the detected current state of the power generation module is within the adequate state range but is out of the preset state area, and controlling the power generation module to adjust the power storage level of the accumulator module to either of the first target storage level and the second target storage level under restricted operation of the power generation module when the detected current state of the power generation module is out of the adequate state range.

The control method of the drive system of the invention controls the power generation module to adjust the power storage level of the accumulator module to the first target storage level, when the detected current state of the power generation module is within the preset state area included in the adequate state range where adequate operation of the power generation module is assured. The control method of the drive system controls the power generation module to adjust the power storage level of the accumulator module to the second target storage level, when the detected current state of the power generation module is within the adequate state range but is out of the preset state area. Namely the power storage level of the accumulator module is adjusted to the second target storage level when there is a possibility that the state of the power generation module currently within the adequate state range will soon depart from the adequate state range. This arrangement ensures adequate regulation of the power storage level of the accumulator module according to the detected state of the power generation module. The control method of the drive system controls the power generation module to adjust the power storage level of the accumulator module to either the first target storage level or the second target storage level under restricted operation of the power generation module, when the detected current state of the power generation module is out of the adequate state range. This arrangement effectively prevents the excessive operation of the power generation module. Here the terminology ‘power storage level’ represents the electric capacity stored in the accumulator module or the state of charge of the accumulator module.

In the control method of the drive system of the invention, the step (b) may set a drive state demand required for the drive module and control the drive module to be actuated in a specific drive state to fulfill the set drive state demand. This arrangement enables the drive module to be actuated in the specific drive state corresponding to the drive state demand. In this case, the step (b) may control the power generation module to generate a higher level of electric power with an increase in loading of the set drive state demand. This arrangement enables the power generation module to generate the electric power in response to the drive state demand. Most of the electric power required for the drive module is thus suppliable from the power generation module.

Further, in the control method of the drive system of the invention, the step (b) may control the power generation module to keep the current state with an increase in power storage level of the accumulator module, when the detected current state of the power generation module is within the adequate state range but is out of the preset state area. This arrangement effectively prevents the state of the power generation module from departing from the adequate state range.

### BRIEF DESCRIPTION OF THE DRAWINGS

FIG. 1 schematically illustrates the configuration of an electric vehicle with a drive system mounted thereon in one embodiment of the invention;

FIG. 2 is a flowchart showing a drive control routine executed by an electronic control unit included in the drive system of the embodiment; and

FIG. 3 shows a torque demand setting map.

### BEST MODES OF CARRYING OUT THE INVENTION

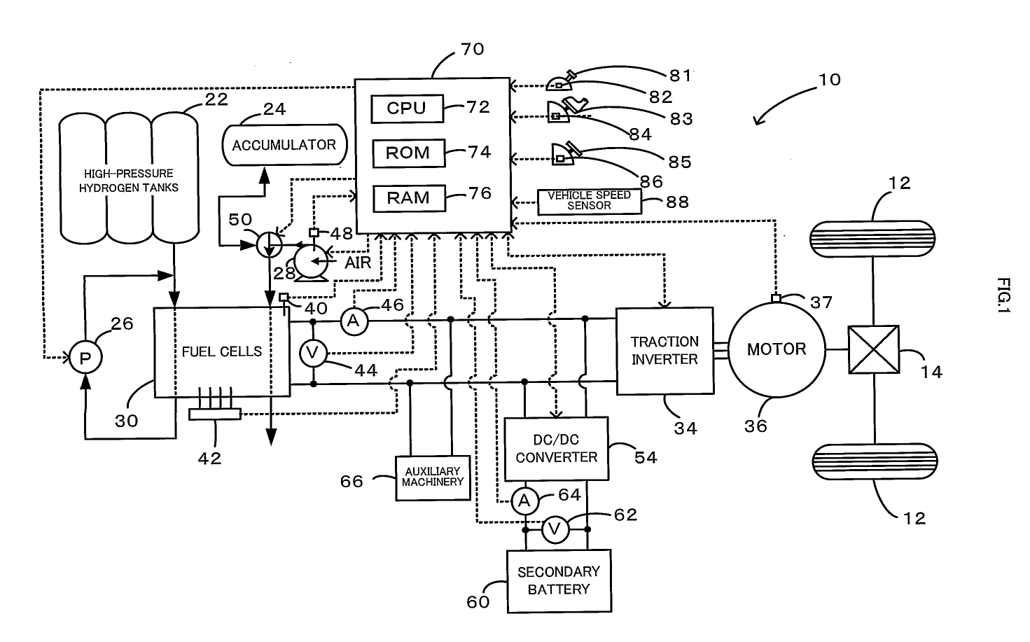

One mode of carrying out the invention is discussed below as a preferred embodiment. FIG. 1 schematically illustrates the configuration of an electric vehicle 10 with a drive system mounted thereon in one embodiment of the invention. As illustrated, the electric vehicle 10 of the embodiment is equipped with a stack of fuel cells 30. The fuel cells 30 receive a supply of a hydrogen-containing fuel gas, which is fed from high-pressure hydrogen tanks 22 and is circulated by means of a circulation pump 26, and a supply of the air, which is fed from an air compressor 28 and an accumulator 24 via a changeover valve 50, and generate DC power through the electrochemical reaction of hydrogen in the fuel gas with oxygen in the air. The electric vehicle 10 includes a traction inverter 34 that converts the DC power generated by the fuel cells 30 into three-phase AC power, and a drive motor 36 that is driven with the three-phase AC power converted by the traction inverter 34 and outputs power to drive wheels 12 via a differential gear 14. The electric vehicle 10 also includes a DC-DC converter 54 that converts the DC power and works to regulate an inter-terminal voltage of the fuel cells 30, a secondary battery 60 that works as a power accumulator and is connected in parallel with the fuel cells 30 via the DC-DC converter 54, high-pressure auxiliary machinery 66 (for example, a compressor in an air conditioner of a passenger compartment) that are actuated with supplies of electric power from the fuel cells 30 and the secondary battery 60, and an electronic control unit 70 that controls the respective constituents of the electric vehicle 10.

The fuel cells 30 have a known stack structure, where multiple unit cells are laid one upon another with separators as partition walls located between adjoining unit cells, although not being specifically illustrated. Each unit cell has an anode and a cathode arranged across an electrolyte membrane. The fuel cells 30 generate electric power through the electrochemical reaction of hydrogen supplied to the anodes through fuel gas conduits formed in the separators with the air supplied to the cathodes through air conduits formed in the separators. The fuel cells 30 have a circulation flow path (not shown) where the flow of a cooling medium (for example, cooling water) is circulated. The circulation of the cooling medium through the circulation flow path keeps the internal temperature of the fuel cells 30 in an adequate range (for example, in a range of 65 to 85° C.).

The drive motor 36 is, for example, a known synchronous motor generator that functions as both a motor and a generator, and is driven with supplies of electric power from the fuel cells 30 and the secondary battery 60 according to the driver's depression amounts of an accelerator pedal 83 and a brake pedal 85 and a measured vehicle speed V.

The electronic control unit 70 is constructed as a microprocessor including a CPU 72, a ROM 74 that is a storage medium to store processing programs, a RAM 76 that temporarily stores data, and input and output ports (not shown). The electronic control unit 70 receives, via its input port, a fuel cell temperature Tfc from a temperature sensor 40 attached to the fuel cells 30, an inter-cell voltage Vcel of the fuel cells 30 from an inter-cell voltage sensor 42, an inter-terminal voltage Vfc from a voltage sensor 44 located between output terminals of the fuel cells 30, an output electric current Ifc from an electric current sensor 46 located on a power line, an air compressor temperature Tac from a temperature sensor 48 attached to the air compressor 28, a rotation position of a rotor in the drive motor 36 from a rotation position detection sensor 37, a phase current applied to the drive motor 36 from an electric current sensor (not shown) attached to the traction inverter 34, a battery voltage Vb from a voltage sensor 62 located between output terminals of the secondary battery 60, a battery current Ib from an electric current sensor 64 attached to the output terminal of the secondary battery 60, a gearshift position currently set by a gearshift lever 81 from a gearshift position sensor 82, an accelerator opening Acc or the driver's depression amount of the accelerator pedal 83 from an accelerator pedal position sensor 84, a brake pedal position BP or the driver's depression amount of the brake pedal 85 from a brake pedal position sensor 86, and a vehicle speed V or current driving speed of the electric vehicle 10 from the vehicle speed sensor 88. The temperature sensor 40, the inter-cell voltage sensor 42, the voltage sensor 44, the electric current sensor 46, and the temperature sensor 48 measure the temperatures, the voltages, and the electric currents as the present conditions of the fuel cells 30 and their auxiliary machinery (for example, the air compressor 28). The electronic control unit 70 outputs, via its output port, drive signals to the circulation pump 26 and to the air compressor 28, switching control signals to the traction inverter 34, DC power conversion signals to the DC-DC converter 54, and changeover signals to the changeover valve 50. The electronic control unit 70 executes operation control of the fuel cells 30 and drive control of the drive motor 36 as discussed later, based on the data received via the input port. The electronic control unit 70 sets an output limit Wout of the fuel cells 30 according to the fuel cell temperature Tfc from the temperature sensor 40, the inter-cell voltage Vcel from the inter-cell voltage sensor 42, the voltage Vfc from the voltage sensor 44, the electric current Ifc from the electric current sensor 46, and the air compressor temperature Tac from the temperature sensor 48. The electronic control unit 70 calculates a current state of charge (SOC) of the secondary battery 60 from the battery voltage Vb from the voltage sensor 62 and the battery current Ib from the electric current sensor 64, and sets a charge demand Pb* of the secondary battery 60 based on comparison between the computed current state of charge (SOC) and a target SOC. The target SOC represents a target value of the charge level of the secondary battery 60. The quantity of electric charge input into and output from the secondary battery 60 is regulated corresponding to the target SOC. The target SOC is not fixed but is varied by the CPU 72 according to the conditions of the fuel cells 30 and their auxiliary machinery as discussed below.

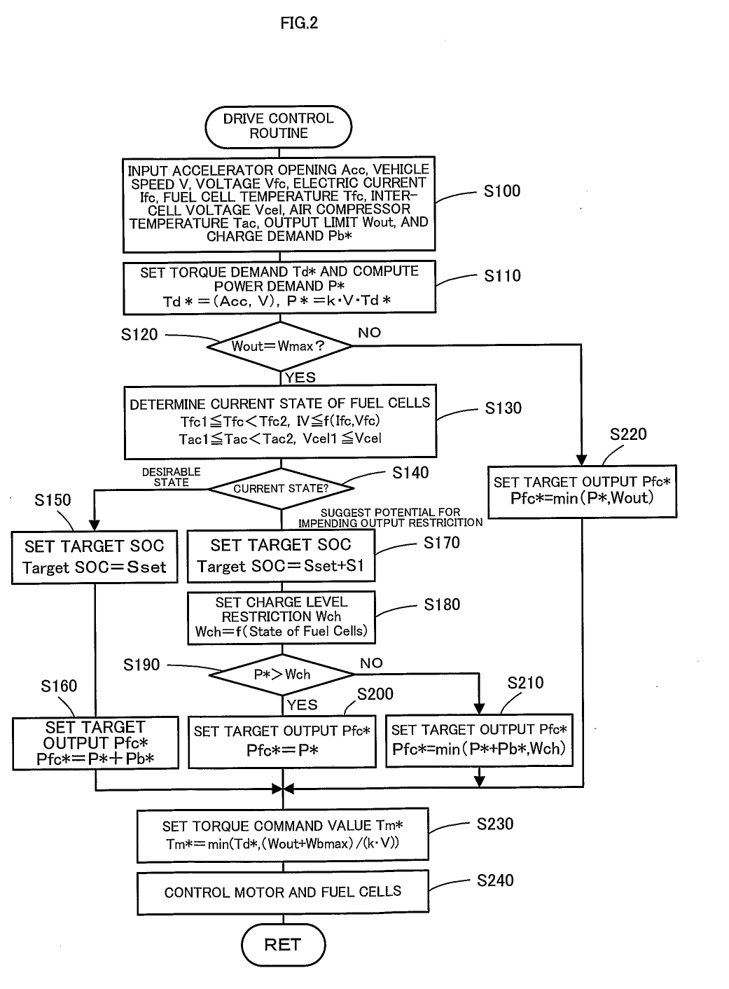

The description regards the operations of the electric vehicle 10 of the embodiment having the configuration discussed above, especially a series of drive control that is related to output restriction of the fuel cells 30 and the target SOC of the secondary battery 60. FIG. 2 is a flowchart showing a drive control routine executed by the electronic control unit 70 of the embodiment. This drive control routine is repeatedly executed at preset time intervals (for example, at every 8 msec). The CPU 72 reads a drive control program stored in the ROM 74 to execute this drive control routine.

In the drive control routine, the CPU 72 of the electronic control unit 70 first receives the data required for control, for example, the accelerator opening Acc from the accelerator pedal position sensor 84, the vehicle speed V from the vehicle speed sensor 88, the fuel cell temperature Tfc from the temperature sensor 40, the inter-cell voltage Vcel from the inter-cell voltage sensor 42, the voltage Vfc from the voltage sensor 44, the electric current Ifc from the electric current sensor 46, the air compressor temperature Tac from the temperature sensor 48, the output limit Wout of the fuel cells 30, and the charge demand Pb* of the secondary battery 60 (step S100). The output limit Wout of the fuel cells 30 has been calculated from the fuel cell temperature Tfc, the inter-cell voltage Vcel, the voltage Vfc, the electric current Ifc, and the air compressor temperature Tac and has been written into the RAM 76 according to an output limit setting routine (not shown). The charge demand Pb* of the secondary battery 60 has been set corresponding to the current state of charge (SOC) of the secondary battery 60 and has been written into the RAM 76 according to a charge demand setting routine (not shown). The CPU 72 accordingly reads the output limit Wout of the fuel cell 30 and the charge demand Pb* of the secondary battery 60 from the RAM 76 at step S100. The technique of setting the output limit Wout of the fuel cells 30 and the charge demand Pb* of the secondary battery 60 is not an essential part of the invention and is thus not described in detail here.

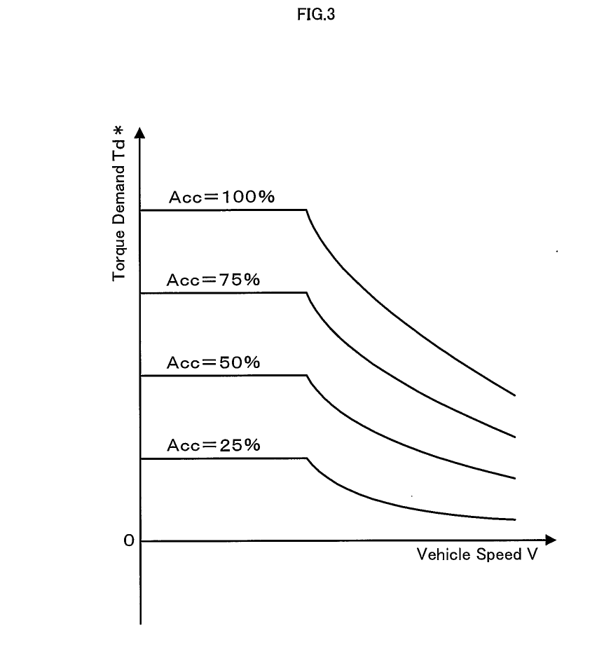

After the input of the required data, the CPU 72 sets a torque demand Td* required for a drive shaft or a rotating shaft of the drive motor 36 as a required driving state of the drive motor 36 according to the input accelerator opening Acc and the input vehicle speed V, and computes a power demand P* required for driving the electric vehicle 10 (step S110). A concrete procedure of setting the torque demand Td* in this embodiment stores in advance variations in torque demand Td* against the accelerator opening Acc and the vehicle speed V as a torque demand setting map in the ROM 74 and reads the torque demand Td* corresponding to the given accelerator opening Acc and the given vehicle speed V from the map. One example of the torque demand setting map is shown in FIG. 3.

The output limit Wout of the fuel cells 30 is compared with a maximum rated output Wmax of the fuel cells 30 (step S120). When the output limit Wout is equal to the maximum rated output Wmax, the fuel cells 30 have no output restriction and are driven under the loading up to the maximum rated output Wmax. When the output limit Wout is lower than the maximum rated output Wmax, the fuel cells 30 have output restriction and are driven under the loading up to the output limit Wout. Under the condition of the output limit Wout equal to the maximum rated output Wmax, the CPU 72 determines whether the current state of the fuel cells 30 suggests a potential for an impeding output restriction, based on the conditions of the fuel cells 30 and their auxiliary machinery, that is, the fuel cell temperature Tfc, the electric current Ifc, the voltage Vfc, the air compressor temperature Tac, and the inter-cell voltage Vcel (step S130). This step determines whether any of the present conditions of the fuel cell temperature Tfc, the electric current Ifc, the voltage Vfc, the air compressor temperature Tac, and the inter-cell voltage Vcel, which are currently in the appropriate drive range with no output restriction of the fuel cells 30, is rather close to a threshold value for imposing the output restriction of the fuel cells 30. For example, an output restriction of the fuel cells 30 is imposed upon condition that the fuel cell temperature Tfc is out of a range between a minimum allowable temperature Tfcmin and a maximum allowable temperature Tfcmax. In this case, the procedure may detect a potential for an impending output restriction of the fuel cells 30 based on the result of determination of whether the fuel cell temperature Tfc is within a range between a temperature Tfc1 higher than the minimum allowable temperature Tfcmin and a temperature Tfc2 lower than the maximum allowable temperature Tfcmax. In another example, an output restriction of the fuel cells 30 is imposed upon condition that a current-voltage characteristic between the electric current Ifc and the voltage Vfc is not higher than a minimum allowable level IVmin. In this case, the procedure may detect a potential for an impending output restriction of the fuel cells 30 based on the result of determination of whether the current-voltage characteristic is not lower than a predetermined level IV1 that is higher than the minimum allowable level IVmin. In still another example, an output restriction of the fuel cells 30 is imposed upon condition that the air compressor temperature Tac is out of a range between a minimum allowable temperature Tacmin and a maximum allowable temperature Tacmax. In this case, the procedure may detect a potential for an impending output restriction of the fuel cells 30 based on the result of determination of whether the air compressor temperature Tac is within a range between a temperature Tac1 higher than the minimum allowable temperature Tacmin and a temperature Tac2 lower than the maximum allowable temperature Tacmax. In another example, an output restriction of the fuel cells 30 is imposed upon condition that the inter-cell voltage Vcel is not higher than a minimum allowable voltage Vcelmin. In this case, the procedure may detect a potential for an impending output restriction of the fuel cells 30 based on the result of determination of whether the inter-cell voltage Vcel is not lower than a predetermined voltage Vcel1 that is higher than the minimum allowable voltage Vcelmin.

When the present conditions of the fuel cells 30 suggest no potential for an impending output restriction of the fuel cells 30, that is, when the fuel cells 30 are in a desirable state (step S140), the CPU 72 sets a standard value Sset to the target SOC of the secondary battery 60 (step S150) and sets the sum of the power demand P* and the charge demand Pb* to a target output Pfc* of the fuel cells 30 (step S160). The target SOC is used in combination with the measured current state of charge (SOC) of the secondary battery 60 to set the charge demand Pb* by the electronic control unit 70 as mentioned previously. Namely the charge demand Pb* is set to cause the current state of charge (SOC) of the secondary battery 60 to approach to the target SOC or to enter or at least approach to a preset range about the target SOC. The CPU 72 then sets the smaller between the torque demand Td* and a quotient of a sum of the output limit Wout and a maximum output Wbmax of the secondary battery 60 by a rotation speed (k·V) of the drive shaft to a torque command value Tm* of the drive motor 36 (step S230). Under such conditions, the fuel cells 30 have no output restriction, so that the output limit Wout is equal to the maximum rated output Wmax of the fuel cells 30. The quotient of the sum of the output limit Wout and the maximum output Wbmax of the secondary battery 60 by the rotation speed (kV) of the drive shaft is thus equivalent to a maximum torque at the vehicle speed V under a supply of a total maximum allowable output power from the fuel cells 30 and the secondary battery 60. The processing of step S230 sets the smaller between the maximum torque and the torque demand Td* to the torque command value Tm*. The torque demand Td* is thus set to the torque command value Tm* in the ordinary state. After setting the torque command value Tm*, the CPU 72 drives and controls the drive motor 36 to output a torque corresponding to the torque command value Tm*, while driving and controlling the fuel cells 30 to output an electric power corresponding to the target output Pfc* (step S240). On completion of the control of the drive motor 36 and the fuel cells 30, the drive control routine is terminated. The control procedure of the drive motor 36 executes a leveling process and a rating process by taking into account the response of the drive motor 36 and regulates switching of the traction inverter 34, thus enabling the drive motor 36 to output the torque corresponding to the torque command value Tm*. The control procedure of the fuel cells 30 executes a leveling process and a rating process by taking into account the response of the fuel cells 30 and regulates actuation of the air compressor 28, the DC-DC converter 54, and the circulation pump 26, thus enabling the fuel cells 30 to output the electric power corresponding to the target output Pfc*.

When the present conditions of the fuel cells 30 suggest a potential for an impending output restriction of the fuel cells 30 at steps S130 and S140, on the other hand, the CPU 72 sets a sum of the standard value Sset and an increase S1 to the target SOC of the secondary battery 60 (step S170). As mentioned above, the charge demand Pb* is set according to the current state of charge (SOC) and the target SOC of the secondary battery 60. The increased target SOC results in setting a higher charge demand Pb* or setting a charge demand Pb* even in the relatively high state of charge (SOC). This heightens the state of charge (SOC) of the secondary battery 60. After setting the target SOC, a charge level restriction Wch of the fuel cells 30 is set corresponding to the present conditions of the fuel cells 30 (the fuel cell temperature Tfc, the electric current Ifc, the voltage Vfc, the air compressor temperature Tac, and the inter-cell voltage Vcel) (step S180). The charge level restriction Wch is set as the maximum output of the fuel cells 30 to keep its current state having the potential for the impending output restriction, when the power demand P* is a relatively low level to allow for charging of the secondary battery 60. Variations in charge level restriction Wch against the fuel cell temperature Tfc, the electric current Ifc, the voltage Vfc, the air compressor temperature Tac, and the inter-cell voltage Vcel are experimentally or otherwise determined and are stored as a charge level restriction setting map in the ROM 74. The procedure of this embodiment reads a charge level restriction Wch corresponding to the given values of the fuel cell temperature Tfc, the electric current Ifc, the voltage Vfc, the air compressor temperature Tac, and the inter-cell voltage Vcel from this map. The charge level restriction Wch is set to decrease with an approach of the present conditions of the fuel cells 30 to conditions for imposing an output restriction. The power demand P* is compared with the charge level restriction Wch (step S190). When the power demand P* is greater than the charge level restriction Wch, the power demand P* is set to the target output Pfc* of the fuel cells 30 (step S200). When the power demand P* is not greater than the charge level restriction Wch, on the other hand; the smaller between the charge level restriction Wch and the sum of the power demand P* and the charge demand Pb* is set to the target output Pfc* (step S210). Under the condition of the power demand P* of greater than the charge level restriction Wch, the procedure controls the fuel cells 30 to cover the power demand P* to a greatest possible extent. Under the condition of the power demand P* of not greater than the charge level restriction Wch, on the other hand, the procedure controls the fuel cells 30 to output the power demand P*, while charging the secondary battery 60 within the range of the charge level restriction Wch. The secondary battery 60 is thus chargeable without making the state of the fuel cells 30 approach to the conditions for imposing an output restriction. The CPU 72 subsequently sets the smaller between the torque demand Td* and the quotient of the sum of the output limit Wout and the maximum output Wbmax of the secondary battery 60 by the rotation speed (k·V) of the drive shaft to the torque command value Tm* of the drive motor 36 (step S230). The CPU 72 then drives and controls the drive motor 36 to output the torque corresponding to the torque command value Tm*, while driving and controlling the fuel cells 30 to output the electric power corresponding to the target output Pfc* (step S240). On completion of the control of the drive motor 36 and the fuel cells 30, the drive control routine is terminated.

When the output limit Wout is lower than the maximum rated output Wmax of the fuel cells 30 at step S120, the fuel cells 30 have output restriction. The CPU 72 accordingly sets the smaller between the power demand P* and the output limit Wout to the target output Pfc* of the fuel cells 30 (step S220). Namely the target output Pfc* of the fuel cells 30 is set within the range of the output limit Wout. The CPU 72 subsequently sets the smaller between the torque demand Td* and the quotient of the sum of the output limit Wout and the maximum output Wbmax of the secondary battery 60 by the rotation speed (k·V) of the drive shaft to the torque command value Tm* of the drive motor 36 (step S230). The CPU 72 then drives and controls the drive motor 36 to output the torque corresponding to the torque command value Tm*, while driving and controlling the fuel cells 30 to output the electric power corresponding to the target output Pfc* (step S240). On completion of the control of the drive motor 36 and the fuel cells 30, the drive control routine is terminated.

In the electric vehicle 10 of the embodiment described above, when the current state of the fuel cells 30 suggests a potential for an impending output restriction, the target SOC of the secondary battery 60 is increased to heighten the state of charge (SOC) of the secondary battery 60 and to make the secondary battery 60 prepare for possible output restriction of the fuel cells 30. The procedure of heightening the state of charge (SOC) of the secondary battery 60 sets the charge level restriction Wch to make the fuel cells 30 keep the current state having the potential for the impending output restriction, and charges the secondary battery 60 within the range of the charge level restriction Wch. The secondary battery 60 is thus chargeable without making the state of the fuel cells 30 approach to the conditions for imposing an output restriction.

The electric vehicle 10 of this embodiment determines whether the current state of the fuel cells 30 has a potential for an impending output restriction, based on the measured values of the fuel cell temperature Tfc, the electric current Ifc, the voltage Vfc, the air compressor temperature Tac, and the inter-cell voltage Vcel. One modified procedure may determine whether the current state of the fuel cells 30 has a potential for an impending output restriction, based on other parameters in addition to these measured values. Another modified procedure may determine whether the current state of the fuel cells 30 has a potential for an impending output restriction, based on any other parameters than the measured values of the fuel cell temperature Tfc, the electric current Ifc, the voltage Vfc, the air compressor temperature Tac, and the inter-cell voltage Vcel.

The electric vehicle 10 of this embodiment sets the sum of the standard value Sset and the fixed increase S1 to the target SOC of the secondary battery 60, when the current state of the fuel cells 30 suggests a potential for an impending output restriction. One modified procedure may set a sum of the standard value Sset and a varying increase corresponding to the state of the fuel cells 30 to the target SOC of the secondary battery 60. The increase may be varied to a greater value with an approach of the present conditions of the fuel cells 30 to conditions for imposing an output restriction.

In the electric vehicle 10 of the embodiment, the procedure of heightening the state of charge (SOC) of the secondary battery 60 sets the charge level restriction Wch to make the fuel cells 30 keep the current state having a potential for an impending output restriction, and charges the secondary battery 60 within the range of the charge level restriction Wch. One modified procedure may charge the secondary battery 60 within the range of a limit value, which is lower than the charge level restriction Wch that makes the fuel cells 30 keep the current state having the potential for the impending output restriction. Another modified procedure may charge the secondary battery 60 within the range of a limit value, which is a little higher than the charge level restriction Wch that makes the fuel cells 30 keep the current state having the potential for the impending output restriction.

The electric vehicle 10 of the embodiment sets the target output Pfc* of the fuel cells 30 according to the power demand P*, whether the current state of the fuel cells 30 suggests a potential for an impending output restriction. Under the output restriction of the fuel cells 30, the target output Pfc* of the fuel cells 30 is set according to the power demand P* within the range of the output limit Wout. The target output Pfc* of the fuel cells 30 may alternatively not be set according to the power demand P*.

The electric vehicle 10 of the embodiment uses the fuel cells 30 as the power generation device. The power generation device mounted on the vehicle is not restricted to the fuel cells 30 but may be a combination of an internal combustion engine and a generator. In this modified structure, the control procedure changes the target SOC of the secondary battery 60 according to the state of at least one of the internal combustion engine and the generator.

The above embodiment regards the drive system mounted on the motor vehicle. The drive system of the invention may be mounted on any of diverse vehicles other than motor vehicles, as well as on any of diverse moving objects including ships, boats, and aircraft. The drive system may also be built in stationary equipment, such as construction machinery. The principle of the invention is not restricted to the drive system but is also actualized by a control method of the drive system.

The embodiment discussed above is to be considered in all aspects as illustrative and not restrictive. There may be many modifications, changes, and alterations without departing from the scope or spirit of the main characteristics of the present invention. All changes within the meaning and range of equivalency of the claims are intended to be embraced therein.

### INDUSTRIAL APPLICABILITY

The technique of the invention is applicable to manufacturing industries of drive systems.

1. A drive system, comprising:
a power generation module that receives a supply of a fuel and generates electric power;
an accumulator module that is chargeable with the electric power generated by said power generation module;
a drive module that is actuated with a supply of electric power discharged from said accumulator module;
a state detection module that detects a current state of said power generation module; and
a control module that controls said power generation module to adjust a power storage level of said accumulator module to a first target storage level when the current state of said power generation module detected by said state detection module is within a preset state area included in an adequate state range where adequate operation of said power generation module is assured,
said control module controlling said power generation module to adjust the power storage level of said accumulator module to a second target storage level when the current state of said power generation module detected by said state detection module is within the adequate state range but is out of the preset state area,
said control module controlling said power generation module to adjust the power storage level of said accumulator module to either of the first target storage level and the second target storage level under restricted operation of said power generation module when the current state of said power generation module detected by said state detection module is out of the adequate state range.

2. A drive system in accordance with claim 1, wherein said control module sets a drive state demand required for said drive module and controls said drive module to be actuated in a specific drive state to fulfill the set drive state demand.

3. A drive system in accordance with claim 2, wherein said control module controls said power generation module to generate a higher level of electric power with an increase in loading of the set drive state demand.

4. A drive system in accordance with claim 1, wherein the second target storage level is higher than the first target storage level.

5. A drive system in accordance with claim 1, wherein the second target storage level is set corresponding to the detected state of said power generation module.

6. A drive system in accordance with claim 5, wherein the second target storage level is set to increase with an approach of the detected state of said power generation module to a boundary of the adequate state range.

7. A drive system in accordance with claim 1, wherein said power generation module comprises a fuel cell stack and auxiliary machinery required for operation of the fuel cell stack, and
said state detection module detects current states of both the fuel cell stack and the auxiliary machinery.

8. A drive system in accordance with claim 7, wherein said state detection module detects at least one of a temperature of the fuel cell stack, a voltage level of the fuel cell stack, a voltage level of a unit fuel cell included in the fuel cell stack, a current-voltage characteristic of the fuel cell stack, and a temperature of the auxiliary machinery, as the current state of said power generation module.

9. A drive system in accordance with claim 1, wherein said control module controls said power generation module to keep the current state with an increase in power storage level of said accumulator module, when the current state of said power generation module detected by said state detection module is within the adequate state range but is out of the preset state area.

10. A drive system, comprising:
an accumulator module that accumulates electric power therein;
a power generation module that generates electric power in an allowable range to a preset output upper limit;
a drive module that is actuated with a supply of electric power discharged from said accumulator module;
a storage level regulation module that accumulates the electric power generated by said power generation module in said accumulator module to a preset target storage level;
an output upper limit change module that changes the output upper limit of said power generation module according to a current state of said power generation module;
a decrease potential detection module that detects a potential for an impending decrease in output upper limit by said output upper limit change module; and
a target storage level rise module that raises the target storage level set by said storage level regulation module, in response to detection of the potential for the impending decrease in output upper limit by said decrease potential detection module.

11. A moving object, comprising:
a power generation module that receives a supply of a fuel and generates electric power;
an accumulator module that is chargeable with the electric power generated by said power generation module;
a drive module that is actuated for moving of the moving object with a supply of the electric power generated by said power generation module and with a supply of electric power discharged from said accumulator module;
a state detection module that detects a current state of said power generation module; and
a control module that controls said power generation module to adjust a power storage level of said accumulator module to a first target storage level when the current state of said power generation module detected by said state detection module is within a preset state area included in an adequate state range where adequate operation of said power generation module is assured,
said control module controlling said power generation module to adjust the power storage level of said accumulator module to a second target storage level when the current state of said power generation module detected by said state detection module is within the adequate state range but is out of the preset state area,
said control module controlling said power generation module to adjust the power storage level of said accumulator module to either of the first target storage level and the second target storage level under restricted operation of said power generation module when the current state of said power generation module detected by said state detection module is out of the adequate state range.

12. A control method of a drive system, which comprises:
a power generation module that receives a supply of a fuel and generates electric power; an accumulator module that is chargeable with the electric power generated by said power generation module; and a drive module that is actuated with a supply of electric power discharged from said accumulator module,
said control method comprising the steps of:
(a) detecting a current state of said power generation module; and
(b) controlling said power generation module to adjust a power storage level of said accumulator module to a first target storage level when the detected current state of said power generation module is within a preset state area included in an adequate state range where adequate operation of said power generation module is assured,
controlling said power generation module to adjust the power storage level of said accumulator module to a second target storage level when the detected current state of said power generation module is within the adequate state range but is out of the preset state area, and
controlling said power generation module to adjust the power storage level of said accumulator module to either of the first target storage level and the second target storage level under restricted operation of said power generation module when the detected current state of said power generation module is out of the adequate state range.

13. A control method of a drive system in accordance with claim 12, wherein said step (b) sets a drive state demand required for said drive module and controls said drive module to be actuated in a specific drive state to fulfill the set drive state demand.

14. A control method of a drive system in accordance with claim 13, wherein said step (b) controls said power generation module to generate a higher level of electric power with an increase in loading of the set drive state demand.

15. A control method of a drive system in accordance with claim 12, wherein said step (b) controls said power generation module to keep the current state with an increase in power storage level of said accumulator module, when the detected current state of said power generation module is within the adequate state range but is out of the preset state area.

16. A control method of a drive system, which comprises:
an accumulator module that accumulates electric power therein; a power generation module that generates electric power in an allowable range to a preset output upper limit; a drive module that is actuated with a supply of electric power discharged from said accumulator module,
said control method comprising the steps of:
(a) changing the output upper limit according to a current state of said power generation module;
(b) raising the target storage level for accumulation in the accumulator module when a potential for an impending decrease in said output upper limit is detected;
(c) accumulating the electric power generated by said power generation module in said accumulator module to a preset target storage level.
